(19) United States
(12) Patent Application Publication
(10) Pub. No.: US 2007/0115376 A1
(43) Pub. Date: May 24, 2007

(54) Image pickup apparatus having two image sensors

(75) Inventor: Tsutomu Igarashi, Tokyo (JP)

Correspondence Address: ARNOLD INTERNATIONAL, P. O. BOX 129, GREAT FALLS, VA, 22066-0129, US

(73) Assignee: OLYMPUS MEDICAL SYSTEMS CORP.

(21) Appl. No.: 11/601,675

(22) Filed: Nov. 20, 2006

(30) Foreign Application Priority Data
Nov. 21, 2005 (JP) 2005-335251

(51) Int. Cl. H04N 9/09

(52) U.S. Cl. 348/262

(57) ABSTRACT

An image pickup apparatus having two image sensors includes two solid state image pickup devices and a prism group that includes a color separation coating that reflects green light. Red and blue transmitting “on chip” color filters are supported on one of the two solid state image pickup devices. The image pickup apparatus has a spectral design to control color shading in changing environments, and is also designed for easy assembly. The spectral design requires that the spectral transmission characteristics of the color separation coating, the red and blue transmitting color filters, and the spectral sensitivity characteristics of pixels of the solid state image pickup devices satisfy certain conditions that pertain to boundaries between the red, blue, and green light. Image readout is provided by combining two adjacent pixels of the image field. A method of manufacturing such an image pickup apparatus is also disclosed.

### CROSS-REFERENCE TO RELATED APPLICATION

This application claims the benefit of foreign priority of JP 2005-335251 filed Nov. 21, 2005, the contents of which are hereby incorporated by reference.

### TECHNICAL FIELD OF THE INVENTION

The present invention relates to an image pickup apparatus having two image sensors, particularly an image pickup apparatus having two image sensors that is suitable for mounting at the end of a medical endoscope.

### BACKGROUND OF THE INVENTION

The image quality of an endoscope, more particularly a so-called videoscope, wherein a solid state image pickup device is arranged at the end of an insertion part, strongly depends on the design of the solid state image pickup device. Previously, high image quality has been sought by reducing the size of the individual detecting unit cells of the solid state image pickup devices, thereby increasing the number of pixels. However, the physical limit of miniaturization of the unit cell size has nearly been reached. Therefore, it will soon be necessary to adopt a different approach to improving image quality. One such approach is to use a plurality of image sensors, more particularly, a plurality of solid state image pickup devices. However, increasing the number of image pickup devices as done previously markedly increases the size of the image pickup apparatus as compared to using a single image pickup device. Therefore, it had been commonly believed that this approach was not practical in the case of videoscopes. Although with today's technology it appears to be impossible to mount a three-sensor image detecting device in a videoscope in order to provide high quality imaging, there is currently a need for an improved two-sensor image detecting device that can be made sufficiently small for use in a videoscope.

The following remarks discuss various prior art two-sensor image detecting devices. Japanese Laid-Open Patent Applications S59-127492 and 2005-210359 disclose different light paths and detector configurations using two image sensors. Japanese Laid-Open Patent Application H5-122710 and Japanese Patent No. 2,929,655 disclose two-sensor image detecting devices with particular color shading. Japanese Laid-Open Patent Applications 2004-258497, H10-304388, H10-341449, H8-68904, and H5-244610 disclose two-sensor image detecting devices using a variety of prism sizes and shapes for splitting light and detection by two solid state image sensors or detectors.

Japanese Laid-Open Patent Application H5-122710, mentioned above, discloses a composition that takes into account the fluctuations of spectral characteristics due to the fluctuations of the angle of incidence by using a dichroic mirror made from a thin plate. However, the obliquely arranged thin plate mirror has the problem that eccentric aberrations may occur in the transmission optical path. Moreover, it is difficult for the thin plate mirror to adopt a frame structure with high reliability compared to a prism, and deformation or displacement due to changes of temperature easily occur, making it difficult to maintain relative position accuracy between the two detectors over time. In addition, in an endoscope exposed to moisture in various situations, moisture easily invades into the space at the front side of the solid state image pickup device, and a deterioration in image quality easily occurs.

Japanese Patent No. 2,929,655, mentioned above, discloses a device with a filter arrangement for the purpose of color shading reduction. The configuration arranges an interference film having a so-called trimming function under specified conditions. In this configuration, the prism configuration becomes complicated because of the arrangement of an inclined interference film, and providing a small size mounting becomes difficult.

Japanese Laid-Open Patent Application 2004-258497, mentioned above, discloses a device designed for miniaturization of the prism structure. However, the prism structure has the problem of being radially oversized for an endoscope.

A prism configuration whose size is radially small and thus suitable for use in an endoscope is disclosed in S57-5537. However, the prism configuration disclosed in S57-5537 tends to make the prism configuration be long in the optical axis direction, which is disadvantageous in that it results in increased length of the rigid end in an endoscope having a curved mechanism at the end. Japanese Laid-Open Patent Applications H10-304388 and H10-341449, both mentioned above, disclose prism configurations wherein two triangular prisms are adhered to form a cube, and Japanese Laid-Open Patent Application H8-68904, also mentioned above, discloses a modification of a triangular, prism-type device for the purpose of preventing ghost light. The prism configuration of Japanese Laid-Open Patent Application H8-68904 is complicated. The prism configurations of Japanese Laid-Open Patent Applications H10-304388 and H10-341449 are simpler and small in size; however, they create problems from the standpoint of securing desirable optical properties in the imaging.

In an endoscope, in order to respond to size and tolerance requirements, a color shading countermeasure must be adopted and assembly properties must be secured after designing a simple prism configuration. However, the two-sensor image detecting device configurations shown in the patent literature discussed above lack consideration of these technical problems. In addition, as a problem unique to the two sensor configurations, the investment needed to resolve these technical problems is great. In the case of a configuration designed to separate green light and magenta light (which is the configuration that can improve the image quality the most), because two separately designed types of solid state image pickup devices are normally required, development expenses and production time are high as compared to using a single image sensor or even three image sensors.

### BRIEF SUMMARY OF THE INVENTION

The present invention relates to an image pickup apparatus having two image sensors with a configuration that enables realizing a size suitable for mounting in the insertion end of an endoscope, that provides high quality imaging without using a complex structure or special elements, that enables the problem of color shading to be solved through proper spectral design, that resolves problems of changing environments and assembly problems, and that improves the return on investment related to solid state image pickup devices.

### BRIEF DESCRIPTION OF THE DRAWINGS

The present invention will become more fully understood from the detailed description given below and the accompanying drawings, which are given by way of illustration only and thus are not limitative of the present invention, wherein:

FIG. 1 is a perspective view of the image pickup apparatus having two image sensors according to Embodiment 1;

FIG. 2 is a diagram showing the arrangement of color filters for mounting on the second image sensor of Embodiment 1;

FIG. 3 is a graph of the transmittance/spectral sensitivity versus wavelength of various components of the image pickup devices used in Embodiment 1;

FIG. 4 is a side view of the image pickup apparatus having two image sensors according to Embodiment 1;

FIG. 5 is graph of the spectral sensitivity versus wavelength of the two solid state image pickup devices used in Embodiment 1;

FIG. 6 is a side view of the image pickup apparatus having two image sensors according to Embodiment 2;

FIG. 7 is a side view of the image pickup apparatus having two image sensors according to Embodiment 3; and

FIG. 8 is a side view of the image pickup apparatus having two image sensors according to Embodiment 4.

### DETAILED DESCRIPTION

For convenience herein, at times, an image pickup apparatus having two image sensors will be referred to simply as a “two-sensor image detecting device”, and an image pickup apparatus having three image sensors will be referred to simply as a “three-sensor image detecting device”. The two-sensor image detecting device of the present invention addresses the problem of color shading as follows. The two-sensor image detecting device of the present invention includes, arranged along an optical axis, a prism group that includes a color separation coating that reflects green light, a first solid state image pickup device that detects images formed by the light reflected by the color separation coating, and a second solid state image pickup device that detects images formed by light transmitted through the color separation coating. Additionally, the second solid state image pickup device directly supports a filter for transmitting red light and a filter for transmitting blue light that has been transmitted through the color separation coating. Furthermore, the two-sensor image detecting device of the present invention satisfies the following conditions:
5 nM≦λ_{iR}−λ_{cR}≦35 nm Condition (1)
−20 nm≦λ_{cB}−λ_{iB}≦20 nm Condition (2)
λ_{iR}−λ_{cR}>λ_{cB}−λ_{iB} Condition (3)

where
λ_{iR} is the wavelength where the spectral sensitivity in the vicinity of the boundary wavelength with a green color becomes 50% relative to light of 600 nm wavelength in the spectral sensitivity curve for a pixel in said second solid state image pickup device having an on-chip filter for red transmission;
λ_{cR} is the wavelength where the mean transmittance becomes 50% at a red boundary in the spectral transmittance curve of said color separating coating for light incident normally onto said coating;
λ_{cB} is the wavelength where the mean transmittance becomes 50% at a blue boundary in the spectral transmittance curve of said color separating coating for light incident normally onto said coating; and
λ_{iB} is the wavelength where the spectral sensitivity in the vicinity of the boundary wavelength with a green color becomes 50% relative to light of 450 nm wavelength in the spectral sensitivity curve for a pixel in said second solid state image pickup device having an on-chip filter for blue transmission.

Hereinafter, in order to simplify explanations, each color band of the three primary colors, red, green, and blue, may be simply described as R, G, and B, respectively. Similarly, the filter for transmitting red light and the filter for transmitting blue light supported on the second solid state image pickup device may be simply described as an “R filter” and a “B filter”, respectively.

In the two-sensor image detecting device of the present invention, a G band with a large contribution to luminance information is imaged by one solid state image pickup device. In order to achieve this, as the color separation coating, two types, a G reflection type and a G transmission type, can be considered. The G reflection type, which provides more degrees of freedom in an interference film design, is used in the present invention. Moreover, in order to separate magenta light, which has been transmitted through the color separation coating, into R and B bands, primary color filtering into the R and B bands is used for the other solid state image pickup device. In general, although the R filter and the B filter have been widely adopted for a solid state image pickup device for a digital still camera having Bayer's arrangement of primary colors, because the optical absorption property of organic pigments is used, the degree of freedom in the spectral characteristic selection is not as high as when using multilayer optical films. However, because this is an absorption-type filter, it has the advantage that the risk of flare and ghost lights, which easily occur with interference filters, is low. Therefore, in the present invention, color shading can be greatly reduced without using an interference trimming filter where flare and ghost lights easily occur and without using an absorption trimming filter that complicates the shape and size of the optical unit outside the solid state image pickup devices. In the present invention, easily produced R filters and B filters themselves can achieve a trimming function that advantageously cooperates with the spectral characteristics of the color separation coating.

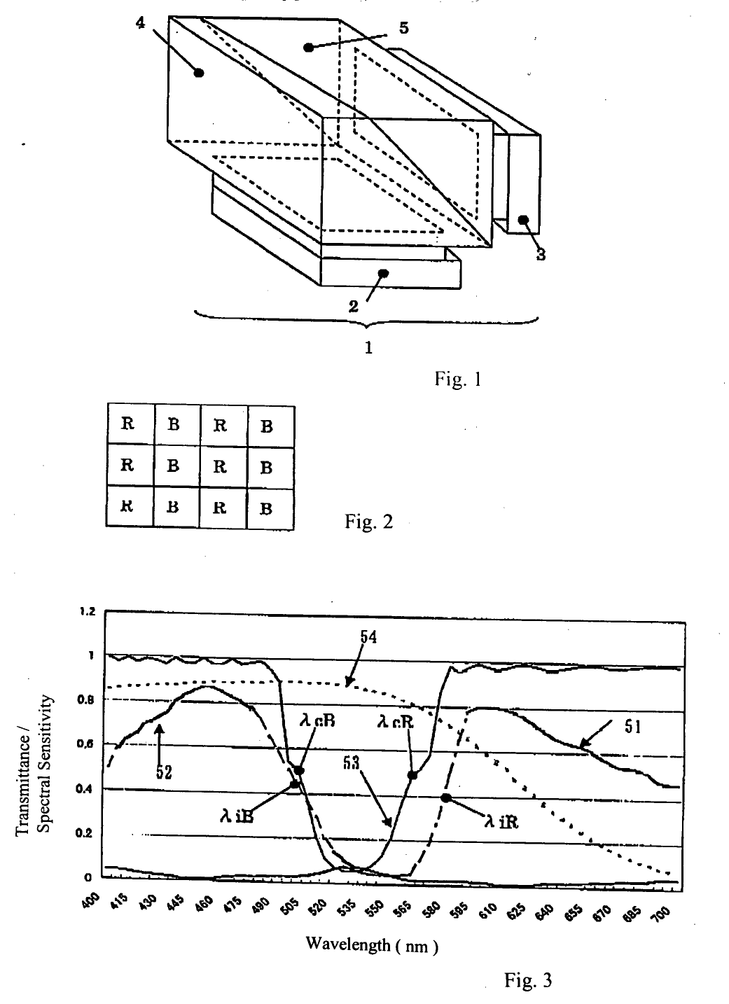

FIG. 1 is a perspective view of the two-sensor image detecting device of Embodiment 1 of the present invention. As shown in FIG. 1, the primary elements of the two-sensor image detecting device 1 are a first solid state image pickup device 2, a second solid state image pickup device 3, a first prism 4 and a second prism 5 configured such that a color separation coating that reflects green light may be arranged on the surfaces where the first prism 4 and the second prism 5 are in contact, and are joined together, for example, by cementing the prisms together. The first solid state image pickup device 2 images a G band image. The second solid state image pickup device 3 directly supports color filters and is designed to enable the separation of magenta light, which has been transmitted through the color separation coating, into the R band and B band. For example, as shown in FIG. 2, the two R and B band color filters are alternately arranged as vertical stripes.

FIG. 3 is a graph of the spectral characteristics of elements of Embodiment 1 that will be used to explain how color shading is avoided in the present invention. The graph of FIG. 3 shows an R filter pixel spectral sensitivity curve 51, a B filter pixel spectral sensitivity curve 52, a spectral transmittance curve 53 for light incident along the optical axis of the color separation coating, and a spectral transmittance curve 54 of an absorption-type infrared cut-off filter. Furthermore, in the present invention, the mean values of a P-polarized light and an S-polarized light are used for the spectral transmittance curve 53 of the color separation coating.

The R filter pixel spectral sensitivity curve 51 is standard for a primary color Bayer's type solid state image pickup device, and it has the above defined wavelength λ_{iR} on the G band boundary. The B filter pixel spectral sensitivity curve 52 is also standard for a primary color Bayer's type solid state image pickup device, and it has the above defined wavelength λ_{iB} on the G band boundary. For the purpose of reflecting G light with a color separation coating, the spectral transmittance curve 53 of such a coating will inherently transmit magenta light, and it has the above defined wavelength λ_{cR} at the R band boundary side and the above defined wavelength λ_{cB} on the B band boundary side.

Hereinafter, in order to simplify explanations, the light energy per R, G or B band is expressed as E_{R}, E_{G} or E_{B}, respectively. Wavelength shifts generated by fluctuations of the angle of incidence of light onto the color separation coating are conceptually equivalent to a shifting of the spectral transmittance curve 53 of FIG. 3 in the horizontal direction. Therefore, fluctuations in spectral transmittance over the wavelength interval of the G band due to fluctuations in the angle of incidence are small. The fluctuation in spectral transmittance for wavelengths longer than the G band is also small because of the shape of the spectral transmittance curve 54 of absorption-type infrared cut-off filters that are generally used, and therefore the change in E_{G} is small. In the R band, where a low transmittance wavelength range of the spectral transmittance curve 53 overlaps the G side sensitivity wavelength range of the spectral sensitivity curve 51, E_{R} decreases. In the B band, where a low transmittance wavelength range of the spectral transmittance curve 53 overlaps the sensitivity wavelength range of the spectral sensitivity 52, E_{B} decreases. These changes of E_{R} and E_{B} cause a fluctuation of the light energy between the bands, which in turn causes the color tone of the picture to change depending on the angle of incidence of light onto the color separation coating. When the angle of incidence of light onto the coating increases (as measured from the surface normal of the coating), the ratio (E_{R}/E_{G}) decreases and the ratio (E_{B}/E_{G}) increases. On the other hand, when the angle of incidence of light onto the coating decreases, the ratio (E_{R}/E_{G}) increases and the ratio (E_{B}/E_{G}) decreases. Therefore, unevenness in the spectral characteristics (which induces color shading) easily occurs for the light separated by an obliquely arranged color separation coating surface.

By satisfying Conditions (1), (2), and (3) above, color shading is controlled without needing to use a complex configuration. The present invention not only achieves this goal, as it also results in providing bright images.

Condition (1) above limits the color difference fluctuation on the R side when the color separation coating spectral transmittance curve 53 shifts towards longer wavelengths. It does this by setting the 50% relative transmittance wavelength of the color separation coating at a shorter wavelength as compared to that of the R filter. In general, since the spectral sensitivity curve 51 of the R pixel filters changes rapidly on the G side, if an overlap occurs due to wavelength shifts, the color difference fluctuation will be large. Because the λ_{iR} to λ_{cR} wavelength range can be established as a low sensitivity wavelength range on the boundary between the R band and the B band, the E_{R} fluctuation is controlled by setting the quantity λ_{iR}−λ_{cR} at a positive predetermined value and appropriately establishing this low sensitivity wavelength band. Furthermore, during critical observations that relate to the main uses in medical endoscopes, there is no purpose in having a specific spectral characteristic in the wavelength band from λ_{iR} through λ_{cR}. Therefore, there is no problem with this band being established in the low sensitivity wavelength range. However, in order to have as great an E_{G} as possible and not to decrease the brightness, it is desirable that the quantity λ_{iR}−λ_{cR} not be too large. Condition (1) above specifies an appropriate value for the quantity λ_{iR}−λ_{cR}. If the lower limit of Condition (1) is not satisfied, the E_{R} fluctuation becomes too large, and if the upper limit of Condition (1) is not satisfied, E_{G} becomes too small and the brightness decreases. Therefore, is desirable that Condition (1) above be satisfied.

Additionally, it is even more preferable that the following Condition (4) is satisfied:
10 nM≦λ_{iR}−λ_{cR}≦25 nm Condition (4)
where λ_{iR} and λ_{cR} are defined as set forth previously.

Condition (2) above relates to the boundary of the B band and the G band, and the circumstances of transmittance and spectral sensitivity are slightly different from those related to Condition (1). In general, since the spectral sensitivity curve 52 of the B filter pixel changes less rapidly on the G side, color difference fluctuations in the case of the occurrence of overlap due to wavelength shifts will be comparatively small. Therefore, specifying λ_{cB} and λ_{iB} to be nearby wavelengths enables the achievement of a balance between color shading control and securing E_{G} for bright imaging. Moreover, the wavelength range between λ_{cB} and λ_{iB} is a range where light absorption by hemoglobin is high, and imaging in this wavelength range is vital for emphasizing blood vessel contrast at the time of critical observations. Consequently, it is not desirable to place a condition (related to the low sensitivity wavelength region at the boundary of the B band and G band) similar to that of Condition (1) above. Instead, Condition (2) specifies an appropriate value of the quantity λ_{cB}−λ_{iB}. If the lower limit of Condition (2) is not satisfied, the E_{B} fluctuation will become excessive. On the other hand, if the upper limit of Condition (2) is not satisfied E_{G} becomes insufficient and the brightness decreases. Therefore, it is desirable to satisfy Condition (2).

Condition (3) above directly relates to relative magnitude of the quantities λ_{iR}−λ_{cR} and λ_{cB}−λ_{iB} used in Conditions (1) and (2) above. If Condition (3) is not satisfied, the balance between the color shading control and securing brightness, specifically related to E_{G}, cannot be achieved, and this of course is undesirable. In addition, it is preferable that the following Condition (5) be satisfied:
λ_{iR}−λ_{cR}>λ_{cB}−λ_{iB}+10 nm Condition (5)
where

λ_{iR}, λ_{cR}, λ_{cB}, and λ_{iB} are defined as set forth previously.

With particular regard to resolving assembly problems and problems arising from changing environmental conditions, the two-sensor image detecting device of the present invention uses: a first prism that includes, arranged in order along an optical axis, a first plane of incidence, a first interface inclined between forty and fifty degrees relative to the first plane of incidence, and a first output plane; a second prism that includes a second plane of incidence joined to the first interface and a second output plane; a color separation coating arranged on the first interface that reflects green light; a first solid state image pickup device that is joined with the first output plane via a first sealing glass plate; and a second solid state image pickup device that is joined with the second output plane via a second sealing glass plate, that detects images formed by light transmitted through the color separation coating, and that directly supports a filter for transmitting red light and a filter for transmitting blue light that has been transmitted through the color separation coating. Additionally, the first prism and the second prism are formed of the same glass material Gₚ having a refractive index of 1.76 or less and an Abbe number of 52 or greater, the first sealing glass plate and the second sealing glass plate are made of the same glass material Gᵢ having a lower ultraviolet transmittance than the glass material Gₚ of the first prism and the second prism, and the following items, namely, the first prism and the second prism, the first prism and the first solid state image pickup device, and the second prism and the second solid state image pickup device are joined using ultraviolet hardening optical adhesives having a refractive index that differs from the refractive index of the glass material Gₚ by 0.15 or less.

Furthermore, the refractive indices and the Abbe numbers used in the explanations herein of the present invention are all measured relative to the d-line.

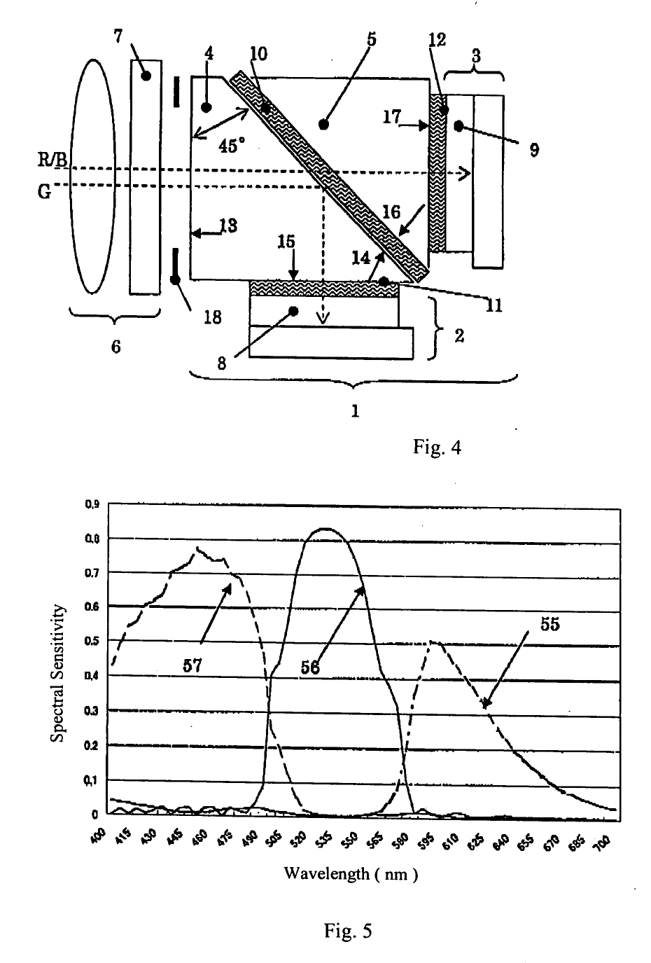

In FIG. 1, the perspective view of Embodiment 1 shows the invention in outline form with solid lines showing visible edges of the elements and dash lines showing edges hidden from view. FIG. 4 shows a side view of Embodiment 1. A detailed explanation of Embodiment 1 follows. In Embodiment 1, two prisms and two solid state image pickup devices are integrated into a unified structure without any air gaps between these elements. In an endoscope, it is essential to make sure the structures avoid causing infections and may be sterilized without damage. Additionally, the insertion part of the endoscope must be designed for being in high moisture and high temperature environments. In particular, in autoclave sterilization, the endoscope is exposed to high pressure steam at approximately 135° C. In a two-sensor image detecting device with a complex configuration, a frame structure cannot be sufficiently sealed from the effects of this environment. Therefore, the two-sensor image detecting device as a whole must have sufficient resistance to moisture and high temperature. In order to prevent condensation on the optical surfaces and glass surface deterioration due to moisture, it is critical that air gaps between optical surfaces not be established within the two-sensor image detecting device. Moreover, if air gaps between optical surfaces were established, the relative positions of the prisms and the solid state image pickup devices would have to be maintained by a frame. However, it is essentially impossible to control a small registration shift (e.g., of a micrometer) given a temperature range from 135° C. in the autoclave to very low temperatures in the transportation environment when the frame structure holds prisms with dimensions of 3.5 mm or smaller. Therefore, a structure where air gaps are between the prisms and the solid state image pickup devices cannot be used in the two-sensor image detecting device for an endoscope.

In the present invention, where the prisms and the solid state image pickup devices are all adhered using optical adhesives, consideration of registration shifts in the adhering and hardening process is also important. In order to adjust the registration before hardening and to adhere the prisms and the solid state image pickup devices and in order to harden the optical adhesives in a short time while proper registration is maintained, it is necessary to use adhesives having ultraviolet hardening properties. However, there is a trade-off between where excessive irradiation of ultraviolet rays to the solid state image pickup devices damages organic raw materials that may be used in microlenses or spectral filters integrated with the solid state image pickup devices and where insufficient irradiation of ultraviolet rays may result in inadequate hardening of the optical adhesives. Therefore, design choices and specifics of the manufacturing processes should be considered together as affecting one another.

Accordingly, in the present invention, the design of the two-sensor image detecting device pays particular attention to the fact that optical adhesives hardened by ultraviolet rays are used, as set forth in the following remarks. The choices of the refractive index being 1.76 or less and the Abbe number being 52 or greater in the glass material Gₚ for the prisms enables assuring high ultraviolet transmittance up to 300 nm. With this design, when hardening the optical adhesive between the two prisms and between the prisms and the solid state image pickup devices by ultraviolet rays, the optical path of irradiation by transmission through the prism becomes usable, increasing the degrees of freedom for the irradiation direction in the ultraviolet ray irradiation device so that choices in the setting processes become greater. Moreover, there is another advantage of using low-dispersion glass with a high Abbe number, namely, enabling the reduction of focal displacements between different color bands generated due to the axial chromatic aberration of the prisms. In addition, setting the ultraviolet transmittance of the glass material Gᵢ for the sealing glass plates lower than that of the glass material Gₚ for the prisms enables setting the ultraviolet irradiation conditions to simultaneously prevent damage to the solid state image pickup devices by ultraviolet rays and to assure complete hardening of the adhesive. The ultraviolet wavelength range where the transmittance of the glass material Gₚ is high and that of the glass material Gᵢ is low is a wavelength range where light may be transmitted through the prism and absorbed by the sealing glass plate. Therefore, setting this wavelength range to be the main wavelength range of the ultraviolet ray irradiation enables complete hardening of the optical adhesives without damaging the solid state image pickup devices even if the irradiation energy and time periods are increased. The reduction of the difference of the refractive indices between the adhesive and the glass material Gₚ contributes to reducing the eccentric aberrations generated when transmitting light through the adhesive layer inclined at 40° to 50°.

With particular regard to the problem of improving the return on investment related to solid state image pickup devices, the two-sensor image detecting device of the present invention includes a prism group that includes a color separation coating that reflects green light, a first solid state image pickup device that detects images formed by the light reflected by the color separation coating, and a second solid state image pickup device that detects images formed by light transmitted through the color separation coating, with the second solid state image pickup device supporting a filter for transmitting red light and a filter for transmitting blue light transmitted through the color separation coating.

The filter for transmitting red light and the filter for transmitting blue light are “on-chip”, vertical stripe filters. Additionally, the first solid state image pickup device and the second solid state image pickup device read from a field of pixels having the same number of pixels of the same size for each of the first solid state image pickup device and the second solid state image pickup device and each of the first solid state image pickup device and the second solid state image pickup device provides readouts based on combining two vertically adjacent pixels.

In the above configuration, the return on investment related to the solid state image pickup devices is improved by using the same solid state image pickup device normally used in a single-sensor image pickup device in a two-sensor configuration. Single-sensor image detecting devices for complementary viewing currently use color image pickup devices in diffusion-type endoscopes where size, cost, and brightness are emphasized more than image quality, and it appears this situation will continue in the future. In these color solid state image pickup devices, because it is conventional during image readout to combine information from two vertically adjacent pixels of the image field, as discussed, for example, in Japanese Laid-Open Patent Application H5-244610, if the number of pixels and the pixel dimensions can be standardized with a similar image reading configuration for a two-sensor configuration, a semiconductor wafer structure, which excludes the optical structure in front of the photoelectric conversion structures, can be standardized. Furthermore, in order to combine two vertical pixels in the second solid state image pickup device that directly supports the spectral filter arrangement “on chip”, it is necessary to use a vertical-stripe-type filter wherein color filters of the same color are aligned vertically.

If the techniques described above are adopted, it becomes possible to adapt the color solid state image pickup devices of single-sensor image pickups that have been developed for diffusion-type endoscopes to a two-sensor arrangement by making relatively minor changes in, for example, the design of the “on chip” micro lenses and color filters that are supported on the wafer structure. Thus, conversions can be made to diffusion-type endoscopes based on a good return on investment and a shortening of development time. On the other hand, if the techniques described above are not adopted, achieving the desired structures becomes difficult due to a greater investment being required and the development time being increased.

As described above, the two-sensor image pickup apparatus of the present invention has a spectral design that enables color shading to be controlled using a simple prism configuration of appropriate size and quality that is mountable to the end of an endoscope. Moreover, the two-sensor image pickup apparatus has excellent environmental resistance and assembly properties, and provides an excellent return on investment due to only small modifications being needed to the conventional solid state image pickup devices used.

Four embodiments will now be discussed in detail with further reference to the drawings and with reference to various tables.

### EMBODIMENT 1

FIG. 1 is a perspective view of the two-sensor image detecting device of Embodiment 1. The image plane of the solid state image pickup device in the video format normally has an aspect ratio such as 4:3 or 16:9, being longer in the depth dimension as shown in FIG. 1, which may be considered the sideways direction

FIG. 4 is a side view of Embodiment 1. The two-sensor image detecting device 1 is used in combination with an objective lens 6. In the case of normal color observation with visible light, an infrared cut-off filter 7 is contained in the objective lens 6. Furthermore, in the case of an endoscope, there are situations that an infrared observation function for deep vessel observation and/or an observation function to emphasize the blood capillaries on the mucosal surface require special spectral characteristic operations in the imaging system. For these observations, special filter arrangements are arranged within the objective lens 6 depending on the observation mode within the two-sensor image detecting device 1, and the versatility of the two-sensor image detecting device 1 is reduced. A flare preventing diaphragm 18 is arranged between the objective lens 6 and the two-sensor image detecting device, as shown in FIG. 4.

The primary elements of the two-sensor image detecting device 1 are the first solid state image pickup device 2, the second solid state image pickup device 3, the first prism 4, and the second prism 5. A two-dimensional detector having a CCD or CMOS structure is used for the first solid state image pickup device 2 and the second solid state image pickup device 3. The image plane of device 2 is protected by a first sealing glass plate 8, and the image plane of device 3 is protected by a second sealing glass plate 9. The first prism 4 has three optical mirror surfaces, a first incident plane surface 13, a first interface 14, and a first output plane 15. The first interface 14 is inclined at 45° relative to the first incident plane surface 13, and the first interface 14 has a color separation coating that reflects green light. The second prism 5 has two optical mirror surfaces, a second incident plane surface 16, and a second output plane 17. For the first prism 4 and the second prism 5, the same glass with moderate or low refractive index and low dispersion is used. For example, S-BSL7 (refractive index: 1.516, Abbe number: 64.1) by Ohara, Inc. may be used. The above four basic elements are integrally combined by adhesive layers 10, 11 and 12 made of the same adhesive material with a refractive index of 1.51 and having ultraviolet hardening properties. The size of the first solid state image pickup device 2 and the second solid state image pickup device 3 is one-sixth inch; the pixel pitch is approximately 2 μm; and the registration displacement tolerance is 1 μm or less. Moreover, the lengths of the matching surfaces of the first prism 4 and the second prism 5 are approximately 2 mm to 3.5 mm, which is considerably smaller than prisms generally used in multiple detector imaging devices for commercial use. The color separation coating is formed by alternately laminating Y₂O₃ (refractive index: 1.86) and Ta₂O₅ (refractive index: 2.21), and a coating having 24 layers or more is used.

The first solid state image pickup device 2 images a green light (G optical path in FIG. 4), which enters from the objective lens 6 side and is reflected by the color separation coating on the first interface 14, in order to produce a G band image. For the first solid state image pickup device 2, a so-called black-and-white type solid state image pickup device that does not directly support a filter is used. However, in order to strictly prevent stray light from mixing with the desired G-light, a directly supported filter for green transmission can be used in the first solid state image pickup device.

The second solid state image pickup device 3 images a magenta light (R/B optical path in FIG. 4), which is transmitted through the color separation coating on the first interface 14.

The first solid state image pickup device 2 and the second solid state image pickup device 3 read pixels from the image field by combining two vertical pixels. Associated with this, the second solid state image pickup device 3 enables the combination of the two vertical pixels as a vertical stripe type arrangement of two colors, R and B, as shown in the arrangement of the directly supported filter in FIG. 2. When producing each band image of R and B in the frame memory, R interpolation to B pixel address and B interpolation to R pixel address is required, and the mean values of two adjacent pixels, right and left, on the frame memory are used. With the image field being read by combining two vertical pixels, the vertical resolution and the quality of still images are inferior to the image field being read by the pixels individually. However, in an endoscope, it is desirable to read the field by combining pixels based on standardizing with single detector imaging devices and the improved sensitivity and the reduction of driving frequency associated with combining pixels. Furthermore, as an all purpose two-sensor image detecting device, structural standardization with the single detector imaging devices may be unnecessary. In that case, after considering issues of image quality, sensitivity and drive frequency, a determination can be made as to whether the field reading of combined pixels or individual pixel reading is appropriate, and the filter arrangement of the second solid state image pickup device 3 can thus be determined.

In all embodiments of the present invention, for the purpose of sealing the components, the prism group in the two-sensor image detecting device 1 and the solid state image pickup devices are integrated without any air gaps. Furthermore, with regard to the objective lens 6 being formed from a circular lens and/or filter, it is possible to adopt measures to exclude moisture by secure sealing properties of the frame structure at the objective lens 6 that is comparatively resistant to thermal expansion or shrinkage, so that there is no problem with air gaps in this portion.

The prism configuration of Embodiment 1 is constructed with two triangular prisms, each prism having a slant face of 45°, which is convenient for miniaturization. This configuration is the most useful for both radial and longitudinal miniaturization, and it is also the simplest.

The following processes are performed in the following order in the assembly of the two-sensor image detecting device 1 of Embodiment 1:
Process (1): performing centering alignment of a G image on the first solid state image pickup device 2 and then joining the first prism 4 and the first solid state image pickup device 2;
Process (2): adjusting the optical path difference between the first solid state image pickup device 2 and the second solid state image pickup device 3, and then joining the second prism 5 to the first prism 4; and
Process (3): performing a registration adjustment of images formed on the first solid state image pickup device 2 and the second solid state image pickup device 3, and then joining the second prism 5 to the second solid state image pickup device 3.

In Embodiment 1, because the color separation coating is located on the first interface 14, the image formation position of the first prism 4 and the first solid state image pickup device 2 does not depend upon the second prism 5, and the image position and the optical path length at the G image side are determined at the time of the completion of Process (1). Therefore, the result of Process (1) will not be affected by Process (2) that follows Process (1). Furthermore, it is possible to arrange that the color separation coating be on the second incident plane surface 16 of the second prism 5. However, in this case, because the image position and the optical path length vary according to the thickness of the adhesive 10, the result of Process (1) is affected by Process (2), complicating the operation of Process (2). Consequently, it is desirable that the color separation coating be arranged on the first interface 14. In Process (2), adjustment is possible using the G image determined in Process (1) as the standard, and the optical path difference between the two detectors can be adjusted by sliding the second prism 5 parallel to the slant face that extends at 45°. Furthermore, in Process (2), thickness variations in the sealing glass plates 8 and 9 are considered at the time of adjusting the optical path difference, and it is desirable that the second solid state image pickup device 3 be temporarily secured in the vicinity of the second prism 5 and the two solid state image pickup devices 2 and 3 are in the imaging state, so that adjustment errors related to image processing are detected. Moreover, registration shift detection related to image processing is effective even in Process (3). Processes (1), (2), and (3) in the configurations described above are effective in resolving assembly problems and problems of changing environments in terms of setting manufacturing processes that take into account the exposure of the solid state image pickup devices to ultraviolet light.

A conventionally known problem in imaging devices is the color shading caused by the characteristics of angle and polarized light related to the color separation coating being arranged on the slant face of 45°. However, in the present invention, the configuration overcomes this color shading problem. In the spectral characteristics of the elements of Embodiment 1 shown in FIG. 3, numerical values related to Conditions (1)-(5) above are as follows:

λ_{cB}=500 nm, λ_{cR}=562 nm

λ_{iB}=500 nm, λ_{iR}=577 nm

λ_{iR}−λ_{cR}=15 nm

λ_{cB}−λ_{iB}=0 nM

FIG. 5 shows spectral energy distributions in Embodiment 1 of the present invention. A spectral sensitivity characteristic of R band light, shown by curve 55 in FIG. 5, is the product of the R filter pixel spectral sensitivity characteristic, shown by curve 51 in FIG. 3, the spectral transmittance of the color separation coating to light incident along the optical axis, shown by curve 53 in FIG. 3, and the spectral transmittance of the absorption infrared cut-off filter, shown by curve 54 in FIG. 3. Curve 57 in FIG. 5 illustrates the spectral characteristic of B band light that is the product of the B filter pixel spectral sensitivity characteristic (shown by curve 52 in FIG. 3), the spectral transmittance of the color separation coating to light incident along the optical axis (shown by curve 53 in FIG. 3), and the spectral transmittance of the absorption infrared cut-off filter (shown by curve 54 in FIG. 3). Curve 56 in FIG. 5 illustrates the spectral characteristic of G band light. It is the product of converting the spectral transmittance (shown by curve 53 in FIG. 3) of the color separation coating to light incident along the optical axis into spectral reflectivity and multiplying the spectral reflectivity by the spectral transmittance of the absorption infrared cut-off filter (shown by curve 54 in FIG. 3). The spectral characteristic of G band light (shown by curve 56) should normally also be multiplied by the spectral sensitivity characteristic of the first solid state image pickup device 2. However, because the spectral sensitivity of the black-and-white solid state image pickup device is comparatively flat in the G band wavelength region, this later multiplication is not required.

The light energies E_{R}, E_{G} and E_{B}, corresponding to R, G or B bands, respectively (as defined previously) can be calculated as the integrated values of the spectral sensitivities, shown by the corresponding curves of FIG. 5. Various values of E_{R}/E_{G} and E_{B}/E_{G} in Embodiment 1 for values of wavelength shift that relate to color shading are shown in Table 1 below.

TABLE 1

| Wavelength shift | E_{B}/E_{G} | E_{R}/E_{G} |
|---|---|---|
| −15 nm | 1.07 (−12%) | 0.62 (±0%) |
| Design value | 1.21 | 0.62 |
| +15 nm | 1.34 (+11%) | 0.60 (−3%) |

The data in the parentheses in Table 1 above indicate the percentage variation from the quantities at the design value with no wavelength shift. In Embodiment 1, because the value of the quantity λ_{iR}−λ_{cR} is set at a relatively large positive value, the percentage variation of E_{R}/E_{G} from the design value is very small and the color shading appears primarily as a variation of E_{B}/E_{G}. However, the total variation of the color shading is approximately 15% according to the absolute value simple sum of the percentage variation of the design values of E_{R}/E_{G} and the percentage variation of the design values of E_{B}/E_{G}. In the case of Embodiment 1, the absolute values simple sum with −15 nm of wavelength shift is 12% and the absolute values simple sum with +15 nm of wavelength shift is 14%, and since both are within 15%, approximately ±15 nm of wavelength shift can be allowed in Embodiment 1.

Next, as an example in the case of not simultaneously satisfying Conditions (1)-(3) of the present invention, an example where λ_{cB} and λ_{cR} shift by +20 nm compared to those in Embodiment 1 is considered. In this new example, λ_{iB} is still 500 nm. This results in the following numerical values related to Conditions (1)-(5) above:

λ_{cB}=520 nm, λ_{cB}=582 nm

λ_{iR}−λ_{cR}=−5 nm

λ_{cB}−λ_{iB}=20 nm

For this new example, various values of E_{R}/E_{G}, E_{B}/E_{G} and the wavelength shift that relate to color shading are shown in Table 2 below.

TABLE 2

| Wavelength shift | E_{B}/E_{G} | E_{R}/E_{G} |
|---|---|---|
| −15 nm | 1.26 (−9%) | 0.62 (+5%) |
| Design value | 1.38 | 0.59 |
| +15 nm | 1.51 (+9%) | 0.53 (−10%) |

In this case, compared to Embodiment 1, the percentage variation of E_{R}/E_{G} is greater, but the percentage variation of E_{B}/E_{G} is smaller. However, the absolute value simple sum with −15 nm of wavelength shift is 14% and the absolute value simple sum with +15 nm of wavelength shift is 19%, so that the color shading generation is greater than that in Embodiment 1. Consequently, the wavelength shift of +15 nm, which is tolerable in Embodiment 1, is exceeded in this new example, which is undesirable.

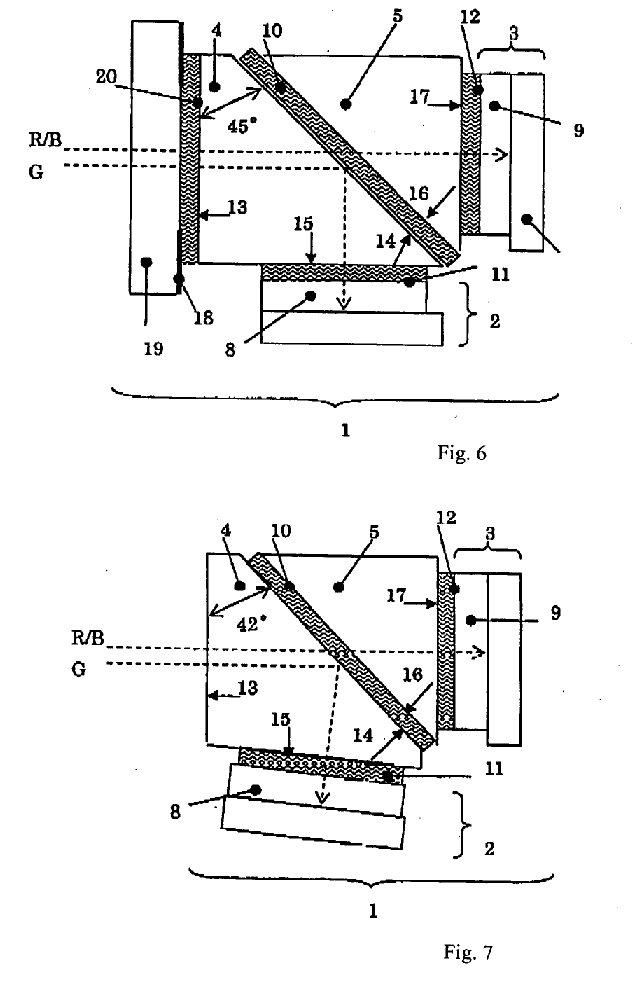

FIG. 6 is a side view of Embodiment 2 of the present invention. Embodiment 2 is characterized by having a prism retaining glass 19 within the two-sensor image detecting device 1. The prism retaining glass 19 is secured to the first incident plane surface 13 of the first prism 4 using an adhesive 20. The adhesive 20 is the same as the adhesives 10 to 12, and after all other joining processes in the two-sensor image detecting device 1, described previously with regard to Embodiment 1, are completed, the prism retaining glass 19 is joined. The prism group in Embodiment 1 needs to be retained by some type of frame, complicating the frame configuration to directly retain the prism. In contrast for the structure in Embodiment 2, as long as it is constructed so as to receive the prism retaining glass 19 in a frame, the prism does not have to be retained by the frame. Therefore, the frame structure can be simplified. In addition, there is an advantage wherein the prism configuration can be determined without considering thermal stress generated between the frame, which is generally formed of metal, and the prisms. Even in this case, the damage to the solid state image pickup devices due to the ultraviolet rays can be avoided by having configurations of the present invention that resolve problems of changing environments and assembly problems. The flare preventing diaphragm 18 is formed on the surface of the prism retaining glass 19 on the first prism 4 side using chrome deposition. With this structure, the flare preventing diaphragm 18 can be mounted within the two-sensor image detecting device 1 after the two-sensor image detecting device 1 is assembled without any air gaps, and flare caused by light at the end of the first incident plane surface 13 can be avoided.

FIG. 7 is a side view of Embodiment 3 of the present invention. The angle of the first interface 14 to the first incident plane surface 13 is 42°, which is different from Embodiment 1. In comparison to Embodiment 1, because the angle of light incident on the surface of the color separation coating is slightly different than in FIG. 6, the reflective properties of the coating are different, thereby causing the difference in reflection of the P-polarized light versus the S-polarized light to be diminished, which is advantageous.

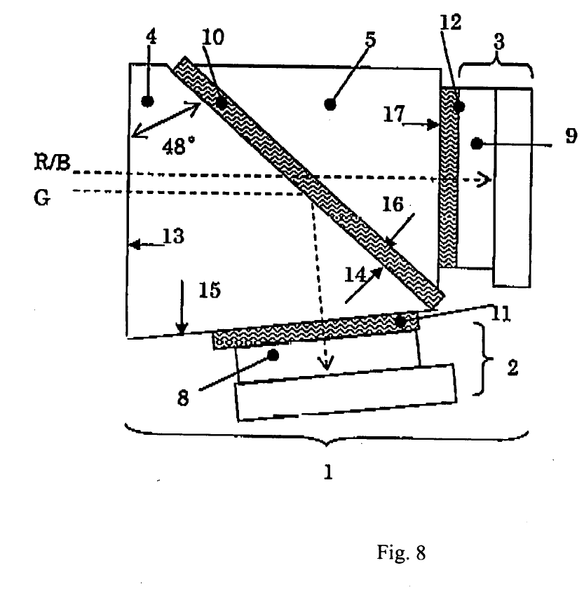

FIG. 8 is side view of Embodiment 4 of the present invention. The angle of the first interface 14 to the first incident plane surface 13 is 48°, which is different from the previous embodiments. This embodiment has merit in that the effective diameter of the first incident plane surface 13 can become greater as compared to that of previous embodiments.

As described above, the angle of the first interface 14 to the first incident plane surface 13 is allowed to vary from 45°. However, if the angle becomes less than 40° or greater than 50°, the inclination of the first solid state image pickup device 2 becomes greater, which is associated with an increasing radial dimension. Therefore, this is not preferable.

The invention being thus described, it will be obvious that the same may be varied in many ways. Such variations are not to be regarded as a departure from the spirit and scope of the invention. Rather, the scope of the invention shall be defined as set forth in the following claims and their legal equivalents. All such modifications as would be obvious to one skilled in the art are intended to be included within the scope of the following claims.

What is claimed is:

1. An image pickup apparatus having two image sensors and an optical axis, said image pickup apparatus comprising:
a prism group that includes a color separation coating that reflects green light;
a first solid state image pickup device that detects images formed by the light reflected by said color separation coating; and
a second solid state image pickup device that detects images formed by light transmitted through said color separation coating, said second solid state image pickup device supporting a filter for transmitting red light and a filter for transmitting blue light transmitted through said color separation coating;
wherein
the following conditions are satisfied:
5 nm≦λ_{iR}−λ_{cR}≦35 nm
−20 nm≦λ_{cB}−λ_{iB}≦20 nm
λ_{iR}−λ_{cR}>λ_{cB}−λ_{iB}
where
λ_{iR} is the wavelength where the spectral sensitivity in the vicinity of the boundary wavelength with a green color becomes 50% relative to light of 600 nm wavelength in the spectral sensitivity curve for a pixel in said second solid state image pickup device having an on-chip filter for red transmission;
λ_{cR} is the wavelength where the mean transmittance becomes 50% at a red boundary in the spectral transmittance curve of said color separating coating for light incident normally onto said coating;
λ_{cB} is the wavelength where the mean transmittance becomes 50% at a blue boundary in the spectral transmittance curve of said color separating coating for light incident normally onto said coating; and
λ_{iB} is the wavelength where the spectral sensitivity in the vicinity of the boundary wavelength with a green color becomes 50% relative to light of 450 nm wavelength in the spectral sensitivity curve for a pixel in said second solid state image pickup device having an on-chip filter for blue transmission.

2. The image pickup apparatus of claim 1, wherein the following conditions are satisfied
10 nm≦λ_{iR}−λ_{cR}≦25 nm
λ_{iR}−λ_{cR}>λ_{cB}−λ_{iB}+10 nm.

3. The image pickup apparatus of claim 1, wherein said prism group comprises:
a first prism that includes, arranged in order along said optical axis, a first surface of incidence, a first interface inclined between forty and fifty degrees relative to said first surface of incidence, and a first output surface;
a second prism that includes a second surface of incidence joined to said first interface and a second output surface; and
said color separation coating is arranged on said first interface.

4. The image pickup apparatus of claim 2, wherein said prism group comprises:
a first prism that includes, arranged in order along said optical axis, a first surface of incidence, a first interface inclined between forty and fifty degrees relative to said first surface of incidence, and a first output surface;
a second prism that includes a second surface of incidence joined to said first interface and a second output surface; and
said color separation coating is arranged on said first interface.

5. An image pickup apparatus having two image sensors and an optical axis, said image pickup apparatus comprising:
a first prism that includes, arranged in order along said optical axis, a first surface of incidence, a first interface inclined between forty and fifty degrees relative to said first surface of incidence, and a first output surface;
a second prism that includes a second surface of incidence joined to said first interface and a second output surface;
a color separation coating arranged on said first interface that reflects green light;
a first solid state image pickup device that is joined with said first output surface via a first sealing glass plate; and
a second solid state image pickup device that is joined with said second output surface via a second sealing glass plate, that detects images formed by light transmitted through said color separation coating, and that directly supports a filter for transmitting red light and a filter for transmitting blue light transmitted through said color separation coating; wherein
said first prism and said second prism are formed of the same glass material having a refractive index of 1.76 or less and an Abbe number of 52 or greater;
said first sealing glass plate and said second sealing glass plate are made of the same glass material having a lower ultraviolet transmittance than the glass material of said first prism and said second prism; and
said first prism and said second prism, said first prism and said first solid state image pickup device, and said second prism and said second solid state image pickup device are joined using ultraviolet hardening optical adhesives having a refractive index that differs from the refractive index of the glass material of said first prism and said second prism by 0.15 or less.

6. A method of manufacturing the image pickup apparatus of claim 5, said method comprising the following steps performed in the indicated order:
(a) performing centering alignment of an image on said first solid state image pickup device and then joining said first prism and said first solid state image pickup device;
(b) adjusting the optical path difference between said first solid state image pickup device and said second solid state image pickup device and then joining said second prism to said first prism; and
(c) performing a registration adjustment of images formed on said first solid state image pickup device and said second solid state image pickup device and then joining said second prism to said second solid state image pickup device.

7. An image pickup apparatus having two image sensors and an optical axis, said image pickup apparatus comprising:
a prism group that includes a color separation coating that reflects green light;
a first solid state image pickup device that detects images formed by the light reflected by said color separation coating; and
a second solid state image pickup device that detects images formed by light transmitted through said color separation coating, said second solid state image pickup device supporting a filter for transmitting red light and a filter for transmitting blue light transmitted through said color separation coating;
wherein
said filter for transmitting red light and said filter for transmitting blue light are vertical stripe filters; and
said first solid state image pickup device and said second solid state image pickup device read from a field of pixels having the same number of pixels of the same size for each of said first solid state image pickup device and said second solid state image pickup device and each of said first solid state image pickup device and said second solid state image pickup device provides readouts based on combining two vertically adjacent pixels.
